(19) United States
(12) Patent Application Publication
(10) Pub. No.: US 2026/0089094 A1
(43) Pub. Date: Mar. 26, 2026

(54) MULTI-DOMAIN RECOVERY SERVICE (MDRS)

(71) Applicant: DISH Wireless L.L.C., Littleton, CO (US)

(72) Inventors: Zeev Render, Ashburn, VA (US); Khalid Al-Mufti, Sterling, VA (US); Jingyi Zhou, Belle Mead, NJ (US)

(21) Appl. No.: 19/043,041

(22) Filed: Jan. 31, 2025

Related U.S. Application Data
(60) Provisional application No. 63/698,716, filed on Sep. 25, 2024.

(51) Int. Cl. H04L 45/302; H04L 41/0668; H04L 45/036

(52) U.S. Cl. CPC H04L 45/304; H04L 41/0668; H04L 45/036

(57) ABSTRACT

A multi-domain recovery service (MDRS) is described for dynamically recovering from network path failures in a communication network. The MDRS can be implemented within an orchestrator of an Open Radio Access Network (O-RAN) architecture.

Upon detecting a trigger condition affecting (e.g., a failure in) a network path that traverses multiple network domains, embodiments query a network topology service and an observability service to obtain high-level and low-level network topology information and real-time network conditions across these domains. Embodiments identify candidate alternative paths by analyzing this comprehensive network data and selects an optimal alternative path based on predefined criteria such as latency, bandwidth capacity, reliability, and traffic load. The orchestrator can then direct the reconfiguration of network components across the multiple network domains to route communications through the new network path, thereby restoring end-to-end connectivity.

### CROSS REFERENCES

This application is a non-provisional of and claims priority to U.S. Provisional Ser. No. 63/698,716 , filed on Sep. 25, 2024, which is incorporated by reference for all purposes.

### FIELD

Embodiments relate generally to communication networks; and, more particularly, to dynamic multi-domain recovery of network path failures in an open radio access network (O-RAN) architecture.

### BACKGROUND

In recent years, the Open Radio Access Network (ORAN, or O-RAN) Alliance, a group of telecom operators, vendors, and research institutions, has worked together to promote and develop open and interoperable solutions in the radio access network (RAN) portion of mobile telecommunications. An O-RAN can refer to a network built around those solutions. For example, an O-RAN can be designed with a flexible, efficient, and cost-effective RAN architecture built around standardized interfaces, virtualized network functions, cloud-based infrastructures, etc.

In such a network, a “network path” can be a path of one or more hops between any two network functions (e.g., anything from the service management and orchestration (SMO) down to the radio). For example, there can be a network path between an O-RAN radio unit (O-RU) and an O-RAN centralized unit (O-CU), including an underlying transport and Kubernetes platform, which can span across several network domains, including an O-RAN cloud infrastructure (O-Cloud), O-RAN Node infrastructures, transport, interfaces, etc. When a network path failure occurs, it can be important to remediate the failure by finding an “alternative path” (AP). If the network path is a path through the O-RAN between two network functions, the AP is an alternate path through the O-RAN between the same two network functions.

Conventionally, alternative path solutions are predefined by network operators to address predicted failures. The alternate path solutions tend to be localized and/or domain-scoped. Such conventional approaches tend to be sub-optimal, particularly from an end-to-end perspective.

### BRIEF SUMMARY

Systems and methods are disclosed for dynamically recovering from network path failures in a communication network using a multi-domain recovery service (MDRS) within an orchestrator of an Open Radio Access Network (O-RAN) architecture. For example, upon detecting a trigger condition affecting (e.g., a failure in) a network path that traverses multiple network domains—including O-RAN nodes, transport domains, and cloud infrastructure—the MDRS queries a network topology service and an observability service to obtain high-level and low-level network topology information and real-time network conditions across these domains. The MDRS can identify candidate alternative paths by analyzing this comprehensive network data and selects an optimal alternative path based on predefined criteria such as latency, bandwidth capacity, reliability, and traffic load. The orchestrator can then direct the reconfiguration of network components across the multiple network domains to route communications through the new network path, thereby restoring end-to-end connectivity.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows an embodiment of a 5G cellular network.

FIG. 2 illustrates an embodiment of a 5G core of a 5G cellular network.

FIG. 3 shows a block diagram of a portion of an O-RAN architecture including a multi-domain recovery service (MDRS), according to embodiments described herein.

FIG. 4 shows a block diagram of a partial O-RAN architecture representing an implementation of the architecture of FIG. 3 having a modified transport interface, according to embodiments described herein.

FIG. 5 shows a block diagram of a partial O-RAN architecture representing an implementation of the architecture of FIG. 3 having an external transport network manager, according to embodiments described herein.

FIG. 6 shows a block diagram of a partial O-RAN architecture representing an implementation of the architecture of FIG. 3 illustrative features of an MDRS, according to embodiments described herein.

FIG. 7 illustrates a first example scenario within an O-RAN architecture in which a network path failure occurs due to the failure of an O-DU.

FIG. 8 illustrates a second example scenario where a network path failure occurs within a transport domain of the O-RAN network due to the failure of a virtualized switch.

FIGS. 9A and 9B show a high-level MDRS call flow within an O-RAN architecture, according to embodiments described herein.

FIG. 10 provides a schematic illustration of an embodiment of a computational system that can implement various system components and/or perform various steps of methods provided by various embodiments.

FIG. 11 shows a flow diagram of an illustrative method for multi-domain network path recovery in an open radio access network (O-RAN) architecture, according to embodiments described herein.

### DETAILED DESCRIPTION

The following detailed description is intended to provide several examples that will illustrate the broader concepts that are set forth herein, but it is not intended to limit the invention or the application and uses of the invention. Furthermore, there is no intention to be bound by any theory presented in the preceding background or the following detailed description.

Systems and methods are described herein for dynamically generating alternate path (AP) solutions in response to a network path failure. The dynamically generated AP solutions use an end-to-end view of the network to select an optimal AP that considers the failure and the present network topology across all described network domains. For example, radio access network (RAN) traffic loading tends to be so dynamic that predetermined, localized solutions produce sub-optimal results. Embodiments described herein involve a real-time, dynamic determination of the recovery AP.

Modern wireless communication networks can be very complex and can be built around complex architectures. For example, some modern wireless communication networks (e.g., those built around “fourth generation” (4G) and “fifth generation” (5G) standards promulgated by standards setting organizations under the umbrella of the Third Generation Partnership Project (3GPP)) include large numbers of different types of communication nodes architected to handle rapidly dynamically changing characteristics across the network. Some advancements in modern wireless communication networks have involved virtualization of many of the functions in the network, such as within a cloud-native architecture.

Some further advancements seek to disaggregate functions of the network, for example, by providing open (e.g., non-proprietary), interoperable functional interfaces. Traditionally, network operators and equipment providers tended to architect their networks and components with proprietary interfaces, which tended to reduce interoperability, efficiency, visibility, etc. However, in recent years, organizations, like the Small Cell Forum, Telecom Infra Project, and 3GPP have advanced efforts to implement disaggregation across network functions. These efforts have led to increasing development and definition around disaggregation of the radio access network (RAN) itself. In particular, many network operators, equipment manufacturers, and others have coalesced around development of the so-called “Open RAN,” or “O-RAN.”

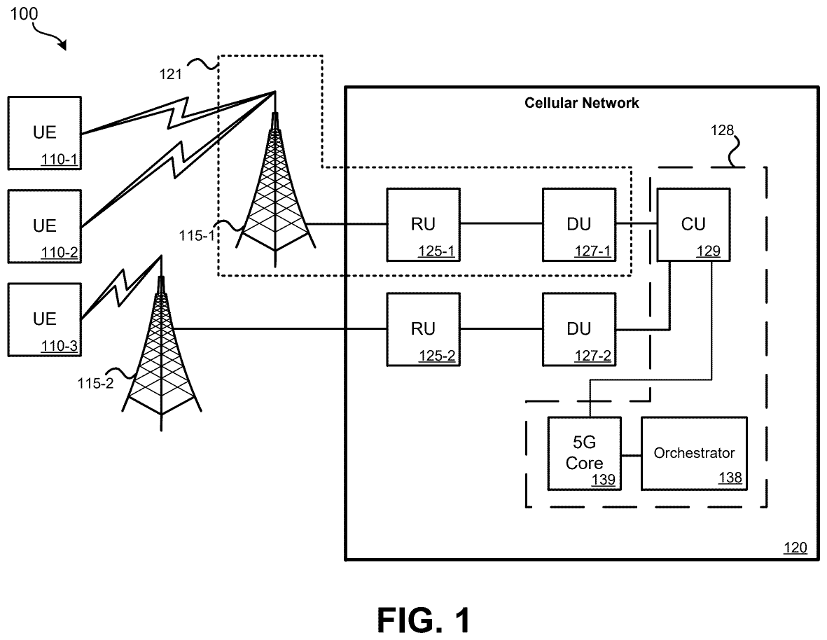

FIG. 1 shows an embodiment of a cellular network system 100 (“system 100”) where various embodiments can be applied. Although system 100 is described and illustrated in a context of 5G, this is not intended to be limiting. Embodiments provided herein can be applied to other types of cell sites when appropriate, such as 4G Long-Term Evolution (LTE), sixth generation (6G), or any other suitable types of networks. The illustrated system 100 can include a 5G New Radio (NR) cellular network; other types of cellular networks are also possible. System 100 can include: UE 110 (UE 110-1, UE 110-2, UE 110-3); base station 115; cellular network 120; radio units 125 (“RUs 125”); distributed units 127 (“DUs 127”); centralized unit 129 (“CU 129”); 5G core 139; and orchestrator 138. FIG. 1 represents a component level view. In an open radio access network (O-RAN), because components can be implemented as software in the cloud, except for components that need to receive and transmit RF, the functionality of the various components can be shifted among different servers to accommodate where the functionality of such components is needed.

UE 110 can represent various types of end-user devices, such as smartphones, cellular modems, cellular-enabled computerized devices, sensor devices, gaming devices, access points (APs), any computerized device capable of communicating via a cellular network, etc. Depending on the location of individual UEs, UE 110 may use RF to communicate with various base stations of cellular network 120. As illustrated, two base stations 115 (BS 115-1, 115-2) are illustrated. Real-world implementations of system 100 can include many (e.g., thousands) of base stations, RUs, DUs, and CUs. BS 115 can include one or more antennas that allow RUs 125 to communicate wirelessly with UEs 110. RUs 125 can represent an edge of cellular network 120 where data is transitioned to wireless communication. The radio access technology (RAT) used by RU 125 may be 5G New Radio (NR), or some other RAT. The remainder of cellular network 120 may be based on an exclusive 5G architecture, a hybrid 4G/5G architecture, a 4G architecture, or some other cellular network architecture. Base station equipment 121, may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of spectrum, such as, for example, “band 71.” One or more DUs, such as DU 127-1, may communicate with CU 129. Collectively, RUs, DUs, and CUs create a gNodeB, which serves as the radio access network (RAN) of cellular network 120. CU 129 can communicate with 5G core 139. The specific architecture of cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

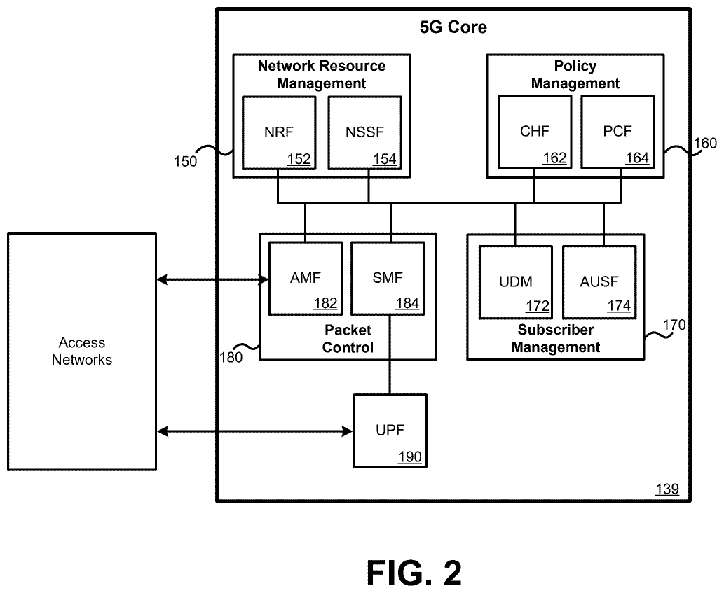

Further detail regarding an illustrative 5G Core 139 is provided in relation to FIG. 2. 5G core 139, which can be physically distributed across data centers or located at a central national data center (NDC), can perform various core functions of the cellular network. 5G core 139 can include: network resource management components 150; policy management components 160; subscriber management components 170; and packet control components 180. Individual components may communicate on a bus, thus allowing various components of 5G core 139 to communicate with each other directly. 5G core 139 is simplified to show some key components. Implementations can involve additional and/or alternative components.

Network resource management components 150 can include: Network Repository Function (NRF) 152 and Network Slice Selection Function (NSSF) 154. NRF 152 can allow 5G network functions (NFs) to register and discover each other via a standards-based application programming interface (API). NSSF 154 can be used by AMF 182 to assist with the selection of a network slice that will serve a particular UE.

Policy management components 160 can include: Charging Function (CHF) 162 and Policy Control Function (PCF) 164. CHF 162 allows charging services to be offered to authorized network functions. A converged online and offline charging can be supported. PCF 164 allows for policy control functions and the related 5G signaling interfaces to be supported.

Subscriber management components 170 can include: Unified Data Management (UDM) 172 and Authentication Server Function (AUSF) 174. UDM 172 can allow for generation of authentication vectors, user identification handling, NF registration management, and retrieval of UE individual subscription data for slice selection. AUSF 174 performs authentication with UE.

Packet control components 180 can include: Access and Mobility Management Function (AMF) 182 and Session Management Function (SMF) 184. AMF 182 can receive connection and session related information from UE and is responsible for handling connection and mobility management tasks. SMF 184 is responsible for interacting with the decoupled data plane, creating updating and removing Protocol Data Unit (PDU) sessions, and managing session context with the User Plane Function (UPF).

User plane function (UPF) 190 can be responsible for packet routing and forwarding, packet inspection, QoS handling, and external PDU sessions for interconnecting with a Data Network (DN) 195 (e.g., the Internet) or various access networks 197. Access networks 197 can include the RAN of cellular network 120 of FIG. 1.

While FIGS. 1 and 2 illustrate various components of cellular network 120, other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible O-RAN implementation, DUs 127, CU 129, 5G core 139, orchestrator 138, can be implemented virtually as software being executed by general-purpose computing equipment, such as in a data center. Therefore, depending on needs, the functionality of a DU, CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components 128 include CU 129, 5G core 139, and orchestrator 138. In some embodiments, DUs 127 may be partially or fully added to cloud-based cellular network components 128. Such cloud-based cellular network components 128 may be executed as specialized software executed by underlying general-purpose computer servers. Cloud-based cellular network components 128 may be executed on a third-party cloud-based computing platform. For instance, a separate entity that provides a cloud-based computing platform may have the ability to devote additional hardware resources to cloud-based cellular network components 128 or implement additional instances of such components when requested.

Kubernetes, or some other container orchestration platform, can be used to create and destroy the logical DU, CU, 5G core units and subunits as needed for the cellular network 120 to function properly. Kubernetes allows for container deployment, scaling, and management. As an example, if cellular traffic increases substantially in a region, an additional logical DU or components of a DU may be deployed in a data center near where the traffic is occurring without any new hardware being deployed (e.g., rather, processing and storage capabilities of the data center would be devoted to the needed functions). When the need for the logical DU or subcomponents of the DU is no longer needed, Kubernetes can allow for removal of the logical DU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new DU, orchestrator 138 can perform a pipeline of calling the DU code from a software repository incorporated as part of, or separate from, cellular network 120; pulling corresponding configuration files (e.g., helm charts); creating Kubernetes nodes/pods; loading DU containers; configuring the DU; and activating other support functions (e.g., instances/connections to test tools).

One feature enabled by modern communication systems, such as 5G NR systems, is the ability to manage resources using network “slices.” A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet particular SLA levels and parameters. By controlling the location and amount of computing and communication resources allocated to a network slice, the SLA attributes for UE on the network slice can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different than the first set, may be reserved at RU 125-2 and DU 127-2. Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and be able to properly respond to changes in the network. In order to ensure not only the functionality and interoperability of such components, but also the ability to respond to changing network conditions and the ability to meet or perform above vendor specifications, significant testing must be performed.

Despite the advancements in network virtualization, orchestration, and the utilization of network slices to optimize resource allocation, network path failures remain a significant challenge in maintaining reliable and efficient network operations. The dynamic and distributed nature of modern networks, particularly with the adoption of O-RAN architectures and virtualized network functions, increases the complexity of managing resources and responding to network changes in real-time. Traditional recovery mechanisms, which often rely on static, predetermined responses, are insufficient to address the rapid and unpredictable failures that can occur across multiple network domains. As described herein, embodiments seek to provide a comprehensive service, referred to herein as a multi-domain recovery service (MDRS), that can dynamically detect and respond to network path failures by considering the entire network's current state and topology (or at least a portion of the network determined to be relevant for consideration).

As used herein, the term “multi-domain” refers to the involvement and coordination of multiple distinct network domains within a communication network during the detection of and recovery from network path failures. These domains encompass, but are not limited to, O-RAN nodes such as O-RAN Radio Units (O-RUs), O-RAN Distributed Units (O-DUs), and O-RAN Centralized Units (O-CUs); transport domains that include the physical and logical transport networks responsible for data transmission between network elements; cloud infrastructures like the O-Cloud that host virtualized network functions and services; and interfaces, whether standardized or proprietary, that facilitate communication between different network components and domains. As used herein, the term “end-to-end” refers to an approach that considers the entire communication path between network elements-from the originating source to the final destination-traversing all relevant network domains within the communication network. By leveraging a multi-domain, end-to-end view, embodiments described herein can dynamically generate and select optimal alternative paths that span the full breadth of the network rather than being limited to localized or single-domain solutions, taking into account the complete network topology and real-time conditions across multiple domains.

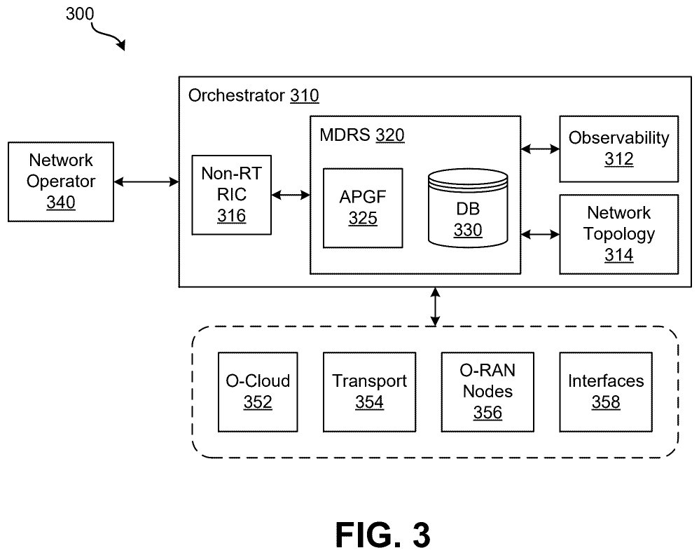

FIG. 3 illustrates a block diagram of a portion of an Open Radio Access Network (O-RAN) architecture 300 incorporating a multi-domain recovery service (MDRS) 320, according to embodiments described herein. The MDRS 320 is implemented within the orchestrator 310. The orchestrator 310 is a centralized platform responsible for the management and orchestration of network functions and resources across the O-RAN system, facilitating efficient control and coordination of various network elements and services. On some embodiments, the orchestrator 310 implements the service management and orchestration (SMO) framework as defined by O-RAN standard-setting organizations, such as the O-RAN Alliance. Embodiments of the orchestrator 310 coordinate and control various network components, including O-RAN Network Function (NF) nodes 356, the O-RAN cloud (O-Cloud) 352, transport domains 354, and interfaces 358. The orchestrator 310 can perform functions, such as configuration management, fault management, performance management, and lifecycle management of network elements, facilitating operations, administration, and maintenance (OAM) across the entire network.

Within the orchestrator 310 communication between different components can be implemented by API calls, via a service bus, and/or in any other suitable manner. Embodiments of the orchestrator 310 can interface with network elements through standardized interfaces. For example, the standard “O1” interface is used to communicate with O-RAN nodes 356, and the standard “O2” interface is used for interactions with the O-Cloud 352 infrastructure (e.g., for seamless integration and interoperability among multi-vendor environments).

As illustrated, embodiments of the orchestrator 310 can include, integrate, or otherwise interact with advanced services. Such services can include an observability service 312, a network topology service 314, and a non-real-time RAN intelligent controller (non-RT RIC) 316. The observability service 312 is a network-wide framework for collecting, aggregating, and exposing events and alarms from various network objects, including infrastructure, platforms, applications, and transport layers. The network topology service 314 supplies detailed information regarding the network's structural layout, including the interconnections between network elements and the current topology configuration. By accessing this information, the MDRS 320 gains an up-to-date understanding of the network's architecture and available resources, which it can use for generating effective alternate paths (APs), as described herein. The non-RT RIC 316 helps to enhance network performance through policy-based guidance and AI/ML model training.

By providing a unified control plane, the orchestrator 310 can enable dynamic resource allocation and/or automated network optimization. This can help to support features, such as the non-RT RIC 316. Implementing the orchestrator 310 within the O-RAN architecture 300 allows operators to achieve greater flexibility, scalability, and efficiency, helping to ensure that the network can adapt to rapidly changing conditions and support diverse service requirements.

Embodiments of the MDRS 320 detect and respond to network path (NP) failures across multiple network domains, including the O-RAN nodes 356, the O-Cloud 352, the transport domains 354, and the interfaces 358. As used herein, a “network path” (NP) refers to an end-to-end communication route between network objects traversing these domains, which may encompass multiple instances of network domains. For instance, a network path might consist of an O-DU (Distributed Unit) connected through a transport network to an O-CU (Centralized Unit), integrating both the relevant transport domain 354 and two O-RAN nodes 356.

The O-RAN nodes 356 generally represent the network function nodes within the O-RAN architecture 300, which can include O-Radio Units (O-RUs), O-Distributed Units (O-DUs), and O-Centralized Units (O-CUs). These nodes are responsible for handling the core functionalities of the radio access network, such as signal transmission and reception, modulation and demodulation, scheduling, resource allocation, and mobility management. In the O-RAN, they are designed to be disaggregated and open, adhering to standardized interfaces that enable interoperability between multi-vendor equipment, thus fostering a more flexible and cost-effective network infrastructure. As described above, the O-RAN nodes 356 can be implemented as software components running on general-purpose hardware, allowing for virtualization and dynamic resource allocation, which enhances scalability and adaptability within the network. Alternative implementation options may include deploying specialized hardware for performance-critical applications or utilizing cloud-based instances to distribute processing loads.

The O-Cloud 352 is the cloud computing infrastructure within the O-RAN architecture 300 that provides computational resources for the execution of virtualized network functions and services. It can include a cloud-native platform built on generic hardware, supporting containerized and virtualized network functions through technologies like Kubernetes and other container orchestration platforms. The O-Cloud 352 facilitates the deployment, scaling, and management of O-RAN network functions such as the O-DU and O-CU, enabling efficient utilization of resources and seamless updates or upgrades. Implementation of the O-Cloud 352 can vary, with options including private cloud infrastructures hosted by the network operator or leveraging third-party public cloud services for enhanced flexibility and cost management.

The transport domains 354 refer to the underlying transport network that interconnects the various components of the O-RAN architecture, including the O-RAN nodes 356, the O-Cloud 352 infrastructure, and other network elements. The transport domains 354 can encompass both the physical and logical network layers responsible for data transmission across the network, utilizing technologies such as Ethernet, fiber optics, and microwave links. The transport domains 354 provide sufficient bandwidth, low latency, and high reliability to meet performance requirements of the network. Implementation options for the transport domain may include traditional networking solutions or more advanced approaches like software-defined networking (SDN) and network slicing to enable dynamic resource allocation and improved network efficiency.

The interfaces 358 represent communication protocols and interfaces (e.g., standard and/or non-standard) that facilitate interoperability and coordination between different network components. For example, the interfaces 358 can include the O1 interface, which enables operations, administration, and maintenance (OAM) functions between the orchestrator 310 and the O-RAN nodes 356. The interfaces 358 can also include the O2 interface, which supports interactions between the orchestrator 310 and the O-Cloud 352 infrastructure. Some or all of the interfaces 358 are designed to be open and standardized as per specifications (e.g., O-RAN Alliance specifications) to promote multi-vendor interoperability and reduce reliance on proprietary solutions. Implementation of these interfaces 358 can involve adhering to defined protocols and may necessitate adaptation or translation layers when interfacing with domains that do not natively support them, such as the transport domains 354. For example, in cases where the transport domains 354 do not support the O1 interface, alternative approaches can be employed, such as defining a new interface or utilizing an External Transport Network Manager (ETNM), as described below.

Embodiments of the MDRS 320 become aware of a NP failure through a trigger mechanism. In some embodiments, or in some cases, the trigger mechanism originates from a network operator 340 (e.g., via manual intervention) when a failure is detected or reported. For example, a network operator may perform maintenance in scheduled maintenance windows, during which the network operator may discover an NP failure. In some embodiments, or in some cases, the trigger mechanism originates from a network operator 340 (e.g., via manual intervention) in connection with a performing certain types of maintenance activities. For example, when a network operator performs a task involving server decommissioning, the network operator may direct services that are leveraging the decommissioned servers to use APs.

In some embodiments, or in some cases, the trigger mechanism is automatically generated by a network function, such as the non-RT RIC 316. In some such embodiments or cases, the non-RT RIC 316 autonomously generates the trigger mechanism based on a predefined policy-based guidance. In some such embodiments or cases, the non-RT RIC 316 includes artificial intelligence and/or machine learning models trained to detect NP failures and to autonomously generate the trigger mechanism, accordingly. Whether originated by the network operator 340 or the non-RT RIC 316, the trigger mechanism can be a trigger signal, or any other suitable mechanism sent to the MDRS 320 to trigger NP failure recovery.

Upon receiving the trigger containing details of the NP failure, the MDRS 320 initiates a recovery procedure. Embodiments of the MDRS 320 query the observability service 312 and the network topology service 314 within the orchestrator 310 to gather essential information for generating one or more recovery options. As described above, the observability service 312 acts as a network-wide framework for the collection, aggregation, and exposure of events and alarms from network objects, including infrastructure, platform, applications, and transport layers; thereby providing the MDRS 320 with real-time insights into network conditions and enabling the MDRS 320 to obtain critical data on alarms, events, network loading, and performance metrics.

Generation of the one or more recovery options and ultimate selection and generation of an alternative network path are performed by an alternate path generation function (APGF) 325 deployed within the MDRS 320. Embodiments of the APGF 325 generate alternative path (AP) solutions in response to the detected NP failure (or scheduled maintenance, or other trigger condition) by identifying candidate APs that can be employed for network recovery. Each candidate AP can be a presently available AP or a newly generated AP.

As illustrated, the MDRS 320 also includes a database 330. Embodiments of the database 330 serve as a repository for storing information about the original NP and details of any generated APs. The stored information can be used for several purposes, including rollback procedures in case the recovery needs to be reversed, debugging issues that may arise during the recovery process, auditing for compliance and performance analysis, and providing historical data that can inform future recovery strategies.

Embodiments of the APGF 325 evaluate each candidate AP by assigning weights based on network performance indicators. For example, the weights can be based on operator-defined criteria, such as bandwidth capacity, reliability, latency, traffic load, and/or number of hops. The weighted assessment enables the APGF 325 to select a best (e.g., most optimal) AP that aligns with the current network conditions and operator preferences. After the APGF 325 selects one of the candidate APs (e.g., a best of the candidates) based on the weighted assessments, the MDRS 320 can communicate the respective AP information for the selected AP to the relevant network domains through appropriate interfaces 358.

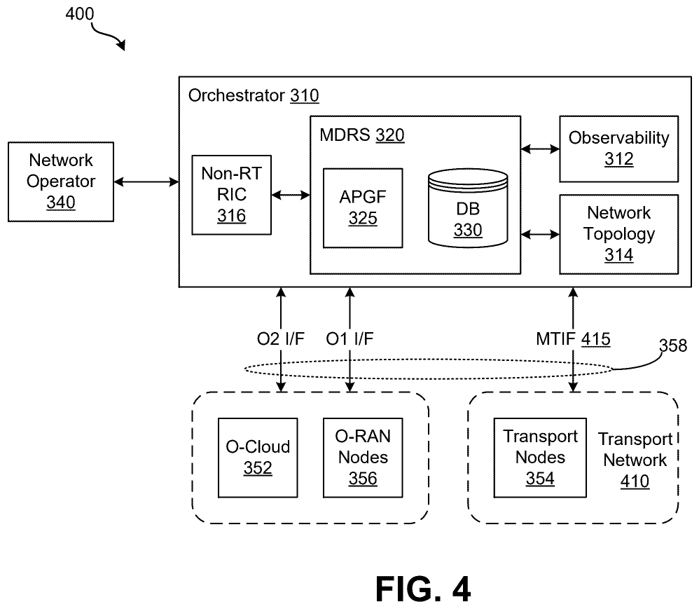

FIG. 4 shows a block diagram of a partial O-RAN architecture 400 representing an implementation of the architecture 300 of FIG. 3 having a modified transport interface (MTIF) 415, according to embodiments described herein. As in FIG. 3, an MDRS 320 is implemented within an orchestrator 310, which manages and coordinates network components, including O-RAN nodes 356, the O-Cloud 352, transport nodes 354, and interfaces 358. FIG. 4 explicitly shows interfaces 358 being used between the orchestrator 310 and network components. As illustrated, the orchestrator 310 can interface with the O-Cloud 352 and O-RAN nodes 356 using standard ones of the interfaces 358, such as the O1 and O2 interfaces. However, the orchestrator 310 interfaces with the transport domains 354 (illustrated as a transport network 410 with transport nodes 354) via a non-standard (e.g., proprietary) modified transport interface (MTIF) 415.

The MTIF 415 provides a direct communication link between the orchestrator 310 and the transport network 410. For example, the MTIF 415 is designed to address compatibility issues that arise because the standard O1 interface used by the orchestrator 310 may not be natively supported by the transport network 410. By introducing the MTIF 415, the orchestrator 310 can effectively interface with the transport network 410 to send configuration payloads and receive notifications, events, and alarms directly. In some implementations, the MTIF 415 replaces or supplements the standard O1 interface when communicating with the transport network 410. The MTIF 415 can be implemented using protocols and communication methods that are natively supported by the transport network 410. For example, implementing the MTIF 415 can include defining a new set of protocols specifically tailored to the transport network's 410 capabilities and/or adapting existing protocols as needed.

Use of the MTIF 415 allows the orchestrator 310 to manage and configure transport network 410 elements without relying on external translators or mediators. For example, when an NP failure occurs, the MDRS 320 can promptly communicate with transport nodes 354 via the orchestrator 310 and the MTIF 415 to reroute traffic, adjust configurations, or implement APs, as determined by the APGF 325. The direct interaction can reduce latency in the recovery process and can allow for more precise control over transport network 410 resources.

FIG. 4 shows standard interfaces being used for interfacing with the O-Cloud 352 and O-RAN nodes 356. For example, the O1 interface is used to communicate with the O-RAN nodes 356, and the O2 is used to communicate with the O-Cloud 352 infrastructure. Alternatively, different standard interfaces, new proprietary interfaces, or any suitable interfaces can be used to facilitate interactions between the orchestrator 310 and the O-Cloud 352 and O-RAN nodes 356.

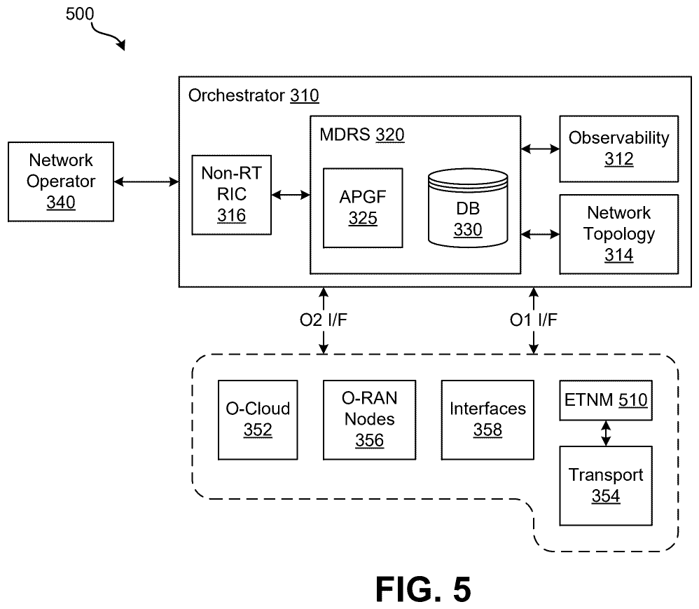

FIG. 5 shows a block diagram of a partial O-RAN architecture 500 representing an implementation of the architecture 300 of FIG. 3 having an external transport network manager (ETNM) 510, according to embodiments described herein. Similar to the previous embodiments of FIGS. 3 and 4, the MDRS 320 is implemented within the orchestrator 310, which manages and coordinates network components, including O-RAN Network Function (NF) nodes 356, the O-RAN cloud (O-Cloud) 352, transport domains 354, and interfaces 358. In the embodiment of FIG. 5, the orchestrator 310 interfaces with the transport domains 354 through ETNM 510, rather than using a MTIF, as in FIG. 4.

Embodiments of the ETNM 510 can be implemented in different ways, depending on specific requirements and capabilities of the transport domains 354. In some implementations, the ETNM 510 is a software application running on dedicated hardware or virtualized within the network infrastructure. In other implementations, the ETNM 510 features are integrated into existing network management systems. The ETNM 510 acts as an intermediary component that facilitates communication between the orchestrator 310 and the transport domains 354 by translating standard interface protocols (e.g., O1 interface protocols) into protocols supported by the transport domains 354. This approach addresses compatibility issues arising from the transport network not natively supporting standard interfaces used by the orchestrator 310.

As illustrates, the ETNM 510 can be implemented as a specialized network management entity that resides outside of the orchestrator 310 but works closely with it to manage the transport network elements. It can receive configuration payloads, notifications, events, and alarms from the orchestrator 310 via the standard (e.g., O1) interface and can translate them into protocols and communication methods that are natively supported by the transport domains 354. Conversely, it can translate transport network protocols back into the standard (e.g., O1) interface format for communication with the orchestrator 310. This bidirectional translation enables seamless interaction between the orchestrator 310 and the transport domains 354 without relying on modifications to either the orchestrator's 310 standard interfaces or the transport domains'354 existing protocols.

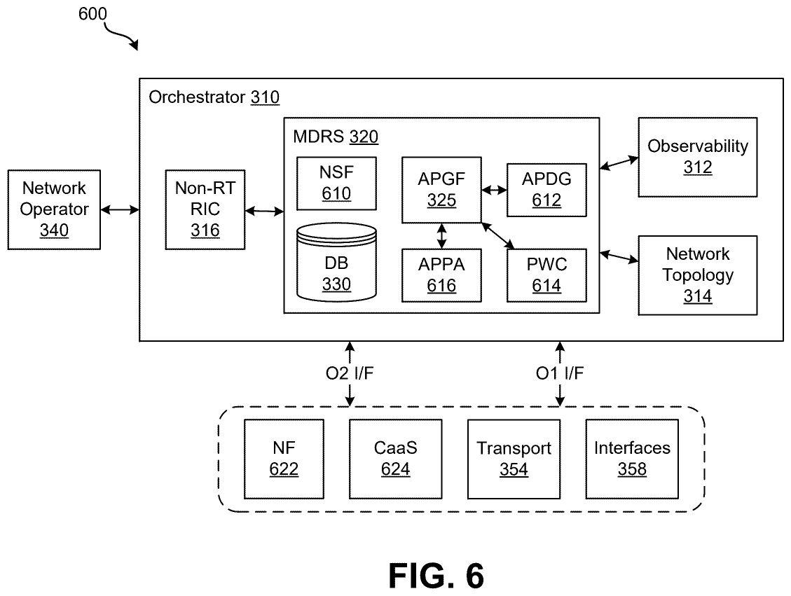

FIG. 6 shows a block diagram of a partial O-RAN architecture 600 representing an implementation of the architecture 300 of FIG. 3 illustrative features of an MDRS 320, according to embodiments described herein. As in FIGS. 3-5, the MDRS 320 is implemented in the orchestrator 310, which oversees the management and orchestration of network functions and resources across the O-RAN system, including O-RAN nodes 356, the O-Cloud 352, transport domains 354, and interfaces 358.

In FIG. 6, the O-RAN nodes 356 are shown as Network Functions (NFs) 622 and the O-Cloud 352 is shown as a Cloud as a Service (CaaS) layer 624. The NFs 622 generally represent virtualized network functions essential for the operation of the network, such as the O-DUs, O-CUs, and other software-defined components. These functions are deployed and managed within a cloud-native environment, allowing for scalable and flexible network operations. The implementation utilizes containerization technologies, where NFs are encapsulated within containers managed by orchestration platforms like Kubernetes. This approach facilitates rapid deployment, scaling, and lifecycle management of network services.

The CaaS layer 624 provides an abstraction platform for deploying and managing the NFs 622. The CaaS layer 624 leverages container orchestration and automation tools to streamline the provisioning and management of network functions. This layer decouples the application layer from the underlying infrastructure, promoting agility and operational efficiency. Alternative implementation options may include Platform as a Service (PaaS) or Infrastructure as a Service (IaaS) models, depending on the desired level of abstraction and control.

Within the MDRS 320, the APGF 325 is shown as integrated with specialized modules, including an alternate path determination/generation (APDG) module 612, a path weight calculation (PWC) module 614, and an alternate path priority assignment (APPA) module 616. Implementation of MDRS 320 features as modules can provide several features. One feature is that such an approach facilitates a modular and scalable approach to network recovery. For example, each module focuses on a specific aspect of the path selection process, facilitating easier updates and enhancements without impacting the entire system. Another feature is that each module can be independently optimized, such as by incorporating advanced artificial intelligence and/or machine learning algorithms to improve path prediction accuracy and adapt to evolving network conditions.

Embodiments of the APDG module 612 determine and generate candidate APs that can be utilized to restore network connectivity. It interfaces with the network topology service 314 and observability service 312 to acquire real-time data regarding network configurations, resource availability, and performance metrics. The APDG module 612 can employ algorithms to analyze this data, considering factors such as geographical locations, network segment characteristics (e.g., bandwidth, reliability, latency, and traffic load), and operator-defined policies to generate viable APs.

The PWC module 614 calculates weights for each candidate AP identified by the APDG 612. The weight represents a quantitative measure of the AP's suitability based on predefined criteria (e.g., number of hops, bandwidth capacity, latency, reliability, and adherence to quality of service (QOS) requirements). Embodiments of the PWC 614 use mathematical models and/or scoring algorithms to assign weights, facilitating an objective comparison of APs. This module enhances the decision-making process by providing a systematic method for evaluating path performance against operator-defined parameters.

Embodiments of the APPA module 616 assign priorities to the APs based on the weights calculated by the PWC 614. Higher priority is allocated to paths with better performance metrics, ensuring that the most optimal path is selected for network recovery. The APPA 616 can employ sorting algorithms and/or threshold-based selection mechanisms to rank the candidate APs.

As illustrated, embodiments of the APGF 325 include and/or interact with a network segmentation function (NSF) 610. The NSF 610 divides the network into manageable network segments, each representing a portion of the network that can be utilized as part of an AP. These segments are selected based on geographical location and additional characteristics such as bandwidth availability, reliability, latency, traffic load, and the number of hops. A network Point of Presence (POP), like a data center, can belong to multiple network segments, such as to segments optimized for reliability and to segments optimized for low latency. Embodiments of the NSF 610 generate low-level information queries to the network topology service 314 for relevant network segments, facilitating efficient retrieval of detailed network information needed for AP generation by the APGF 325.

Although FIGS. 4-6 highlight particular features of implementations of FIG. 3, other implementations can include any suitable combination of those features. As one example, FIG. 3 can be implemented with the MDRS 320 of FIG. 6, including some or all of the NSF 610, APDG module 612, PWC module 614, and/or APPA module 616. As another example, FIG. 6 can be implemented with the MTIF 415 of FIG. 4 or the ETNM 510 of FIG. 5.

Embodiments of the MDRS 320 can perform NP failure recovery in different ways. In one approach, the APGF 325 uses the NSF 610 to identify candidate APs. The NSF 610 divides the network into segments based on geographical locations and/or network characteristics such as bandwidth, reliability, latency, and traffic load. By focusing on relevant network segments, the APGF 325 queries the network topology service 314 for detailed information on these segments, efficiently retrieving candidate APs that traverse optimal paths. This reduces computational complexity by limiting the search space to specific segments, allowing the APGF 325 to generate APs that are geographically and technically suitable for the NP failure scenario.

In another approach, the APGF 325 functions without leveraging the NSF 610, analyzing the entire network topology to identify candidate APs. In this approach, the APGF 325 accesses comprehensive network data from the network topology service 314 and considers all possible routes between the source and destination nodes. It evaluates each candidate AP based on factors such as hop count, bandwidth availability, latency, and current network traffic conditions. By not restricting the search to predefined segments, this approach increases the possibility of finding unconventional or previously underutilized paths that can be effective in restoring network connectivity.

Another approach involves the APGF 325 computing weighted scores for each candidate AP based on operator-defined criteria. Each criterion, such as bandwidth capacity, latency, reliability, and traffic load, is assigned a specific weight reflecting its importance to the network's performance goals. The APGF 325 calculates a composite score for each AP by summing the weighted values of these criteria. Candidate APs are then ranked according to their composite scores, and the highest-ranking AP is selected as the new network path. This approach allows for a customizable and quantitative assessment of APs, aligning the selection process closely with the operator's priorities and service level agreements.

In another approach, the APGF 325 integrates machine learning algorithms to enhance the identification and selection of candidate APs. By analyzing historical network performance data and real-time metrics from the observability service 312, the APGF 325 trains predictive models to anticipate network conditions and potential bottlenecks. When a NP failure occurs, the APGF 325 uses these models to predict the performance of candidate APs under current conditions. This predictive capability enables the APGF 325 to select an AP that is not only suitable based on present metrics but is also likely to remain optimal in the near future, thereby improving network reliability and performance.

In another approach, the APGF 325 employs a priority-based system without computing weighted scores. Operators define specific rules or policies that prioritize certain APs over others-for example, preferring paths that use certain high-capacity links or that avoid congested network areas. When generating candidate APs, the APGF 325 filters and ranks them based on these predefined priorities. This can simplify the selection process and reduce computational overhead, allowing for faster recovery times.

Another approach involves the APGF 325 actively generating new APs by provisioning additional network resources or reconfiguring existing ones. Instead of relying solely on existing network paths, the APGF 325 can collaborate with the orchestrator 310 to deploy backup hardware, activate dormant links, modify network configurations, and/or otherwise create new nodes and/or routes. This can expand the pool of candidate APs and can be particularly useful in situations where traditional paths are unavailable or insufficient due to extensive network failures or capacity constraints.

In another approach, the APGF 325 focuses on a particular criterion to optimize performance in networks where performance is dominated by that criterion. In one such approach, the APGF 325 identifies the shortest possible paths (e.g., in terms of hop count) for the new network path. By utilizing algorithms that prioritize “shortness” (e.g., minimal hop counts), the APGF 325 selects APs that potentially offer lower latency and reduced transmission delays. Such an approach simplifies the selection criteria and expedites the decision-making process.

In another approach, the APGF 325 can consider real-time network load. For example, by accessing up-to-date traffic information from the observability service 312, the APGF 325 assesses the current utilization levels of different network segments. It prioritizes APs that traverse less congested routes to avoid potential bottlenecks and ensure smoother data flow. This dynamic approach can help the network adapt to fluctuating traffic patterns, enhancing overall performance during recovery operations.

In another approach, the APGF 325 can consider policy-based decision-making. Operators establish policies that dictate AP selection based on regulatory requirements, security considerations, contractual obligations with third parties, etc. For example, certain network segments may be designated for specific types of traffic or may be restricted due to compliance issues. The APGF 325 can apply these policies when evaluating candidate APs to ensure that the selected path aligns with all operational guidelines and legal requirements.

In another approach, the APGF 325 can use a hybrid approach that combines multiple of the above and/or other approaches to optimize AP selection. The hybrid approach can consider multiple factors serially or in parallel. As one example, the APGF 325 first uses the NSF 610 to narrow down potential APs to specific network segments, then applies weighted scoring based on operator-defined criteria, and finally incorporates real-time network load data to make a final selection.

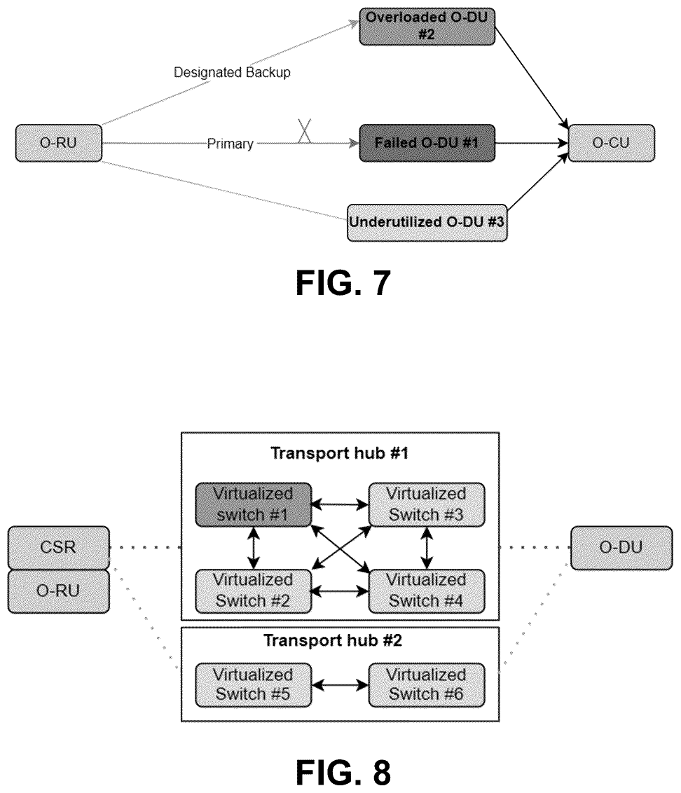

FIG. 7 illustrates a first example scenario within an O-RAN architecture in which a network path failure occurs due to the failure of an O-DU. As described above, an O-RU is responsible for the transmission and reception of radio signals to user equipment (UE) and is connected to an O-DU that handles the real-time processing of lower-layer protocols such as the Physical (PHY) and Medium Access Control (MAC) layers. As illustrated, there are three O-DUs disposed between the O-RU and a particular O-CU, illustrated as “O-DU #1” which was presently being used but has just failed; “O-DU #2” which is presently overloaded; and “O-DU #3” which presently underutilized. The failure of the O-DU disrupts the primary network path between the O-RU and the core network via an O-CU, necessitating an immediate alternative path solution to maintain network service continuity.

In a conventional domain-scoped approach, the network would tend to have one of the O-DUs pre-designated as a primary O-DU (O-DU #1 in the illustrated scenario) and another O-DU pre-designated as a backup O-DU (O-DU #2 in the illustrated scenario). For example, the recovery process can involve instantiating a new O-DU by provisioning a Kubernetes node for the O-DU NF, downloading necessary artifacts, and applying the O-DU configuration. While such an approach can be effective under normal circumstances, the approach assumes that the pre-designated backup O-DU has sufficient capacity to handle the additional load. However, in the illustrated scenario, O-DU #2 is already overloaded at the time of failure, rendering it a poor choice for backup. Overloading an O-DU can lead to degraded performance, increased latency, and potential service outages for connected UEs.

Real-world cases where such a scenario could occur include situations where network traffic surges unexpectedly, such as during large public events, emergencies, or peak usage hours. Hardware failures, software bugs, or power outages can also cause sudden O-DU failures. Additionally, maintenance activities or configuration errors might inadvertently bring down an O-DU.

Embodiments of the MDRS 320, such as described in FIGS. 3-6, leverage a comprehensive, end-to-end view of the network to identify and implement an optimal alternative path. The MDRS 320 is designed to have visibility into all relevant network domains, including O-RAN nodes 356, the O-Cloud 352, transport domains 354, and interfaces 358. This holistic perspective enables the MDRS 320 to consider factors such as current network topology, real-time utilization parameters, and operator-defined policies when generating recovery solutions.

For example, in the illustrated scenario, the O-DU failure can be identified through alarms and events collected by the observability service 312 within the orchestrator 310. In response, the MDRS 320 is triggered to initiate the recovery process. The non-RT RIC 316 may also autonomously detect the failure based on AI/ML models and policy-based guidance, providing additional triggers to the MDRS 320. The MDRS 320 queries the network topology service 314 to obtain detailed, dynamic information about the network's current state. This includes high-level information such as data center locations and low-level details like server types, utilization percentages, server interfaces, and transport nodes. By accessing this information, the MDRS 320 identifies that O-DU #3 is underutilized and is geographically suitable as an alternative to the failed O-DU #1.

The APGF 325 within the MDRS 320 evaluates potential alternative paths. It employs modules such as the NSF 610 to divide the network into segments based on characteristics like bandwidth, reliability, and traffic load. The PWC module 614 calculates weights for each candidate path, considering operator-defined criteria such as latency requirements and resource availability. The APPA module 616 assigns priorities based on these weights, selecting the most optimal path. In this scenario, the MDRS 320 determines that reconfiguring the O-RU to connect to O-DU #3 is the optimal solution. The MDRS 320 coordinates the necessary reconfiguration steps, which may include updating the O-RU's configuration to establish connectivity with O-DU #3 and adjusting the O-CU configurations to accommodate the new O-DU association. The O-CU handles higher-layer RAN protocols and needs to be aware of the change to maintain seamless operations.

Additionally, the MDRS 320 communicates these configuration changes to the relevant network domains using appropriate interfaces 358. For example, for the O-RU and O-DU configurations, the standard O1 interface facilitates OAM functions; and if adjustments to the cloud infrastructure are involved, the O2 interface can enable interactions with the O-Cloud 352. The MDRS 320 may also coordinate with relevant transport domains 354 to ensure that data flows are correctly routed through the new path. Notably, the MDRS 320 effectively bypasses the overloaded O-DU #2 and restores network services through O-DU #3, resulting in a fast recovery process and optimal utilization of available network resources and minimizing service disruption for end-users.

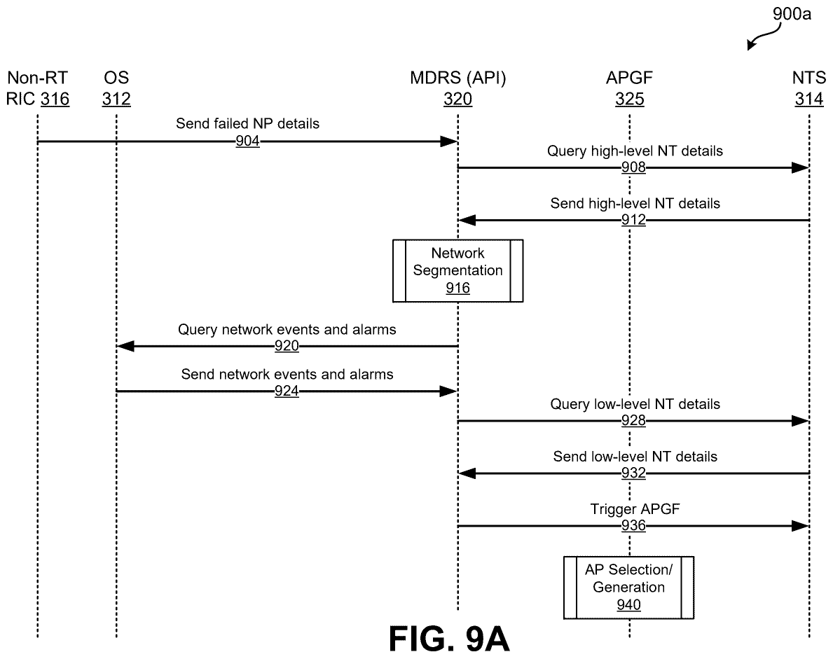

FIG. 8 illustrates a second example scenario where a network path failure occurs within a transport domain 354 of the O-RAN network due to the failure of a virtualized switch. The illustrated example is representative of a transport layer failure. A transport layer failure in 5G and O-RAN networks occurs when communication links—fronthaul, midhaul, or backhaul—connecting key components such as the O-CU, O-DU, and O-RU are disrupted. These links are critical for seamless data transfer and signaling, directly influencing the network's performance and stability. Maintaining the resilience of O-RAN networks can rely on ensuring rapid recovery from such failures.

In the illustrated scenario, virtualized Switch #1, located within Transport Hub #1, fails, thereby disrupting the data transmission paths that rely on it. The transport domains 354 are connect various O-RAN components, and the failure of a key switch can significantly impact network performance and service delivery. A conventional domain-scoped recovery would tend to utilize a pre-designated alternative switch within the same transport hub, such as Virtualized Switch #2 in Transport Hub #1. However, if Transport Hub #1 is experiencing high utilization or overloading, using an alternative switch in the same hub may exacerbate congestion and degrade network performance. Real-world scenarios leading to such failures include hardware malfunctions, software errors, cyber-attacks, or excessive traffic loads that overwhelm network components. For instance, during peak usage periods or unexpected events causing spikes in data transmission, transport network elements may become overutilized or fail, necessitating swift and effective recovery strategies.

Embodiments of the MDRS 320, such as described in FIGS. 3-6, leverage a comprehensive, end-to-end view of the network to identify and implement an optimal alternative path. The MDRS 320 is designed to have visibility into all relevant network domains, including O-RAN nodes 356, the O-Cloud 352, transport domains 354, and interfaces 358. The MDRS 320 can leverages its comprehensive, multi-domain visibility into the network topology and real-time events to consider alternative options beyond the immediate domain of failure. By querying the network topology service 314, the MDRS obtains detailed information about the status and utilization of transport nodes across the network.

In this scenario, the MDRS 320 identifies that virtualized switches within Transport Hub #2 are underutilized and are capable of handling additional traffic. The APGF 325 evaluates the feasibility of rerouting data flows through Transport Hub #2. The PWC module 614 assesses factors such as additional latency due to the new path, available bandwidth, and overall impact on network performance. The APPA module 616 prioritizes this alternative based on the calculated weights and operator-defined policies. The MDRS 320 then orchestrates the necessary configuration changes to implement the new network path. This involves updating routing configurations, adjusting network function parameters, and ensuring that data packets are correctly forwarded through the new virtualized switches in Transport Hub #2. The MDRS 320 communicates with the transport domains 354 using appropriate interfaces 358. For example, if the standard O1 interface is not supported by the relevant transport domain(s) 354, mechanisms like the MTIF 415 of FIG. 4 or the ETNM 510 of FIG. 5 facilitate the necessary communication and configuration updates.

Additionally, the MDRS 320 ensures that upstream and downstream network components are aware of the path changes. This may involve updating the configurations of O-RAN nodes 356, such as O-DUs and O-CUs, and/or notifying the Non-RT RIC 316 for any policy adjustments. By coordinating these changes across multiple domains, the MDRS 320 maintains service continuity and minimizes the impact on end-users.

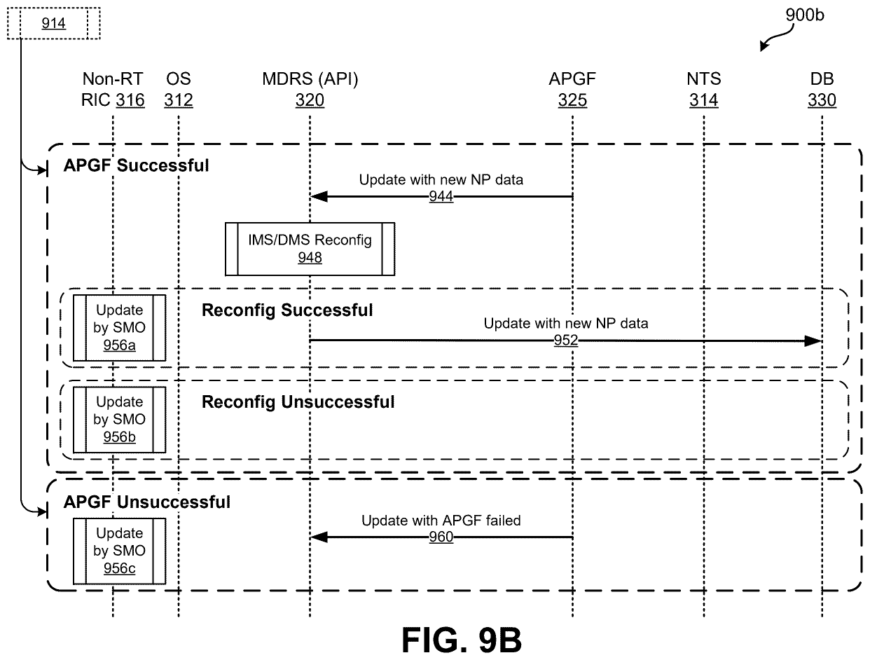

FIGS. 9A and 9B show a high-level MDRS 320 call flow 900 within an O-RAN architecture, according to embodiments described herein. Turning first to FIG. 8A, the flow 900a begins at stage 904 when a trigger condition (e.g., a network path (NP) failure, scheduled maintenance, etc.) is detected, either by the non-RT RIC 316 or by the network operator 340. The non-RT RIC 316, equipped with policy-based guidance and artificial intelligence/machine learning (AI/ML) capabilities, may autonomously identify the failure through continuous monitoring of network performance metrics, alarms, and events. Alternatively, the network operator 340 may manually detect the failure using operational monitoring tools and systems. In either case, detailed information about the failed network path, including the affected network elements, the nature of the failure, and any relevant context, is provided to the MDRS 320 via an application programming interface (API) call.

Upon receiving the failed path details, the MDRS 320 initiates a series of queries to gather comprehensive information for generating an effective alternative path. At stage 908, the MDRS 320 queries the network topology service 314 for high-level network topology (NT) details. The network topology service 314 maintains an up-to-date repository of the network's structural layout, including the interconnections between major network segments, nodes, and domains such as the O-RAN nodes 356, the O-Cloud 352, and the transport domains 354. The network topology service 314 updates the MDRS 320 with relevant high-level NT information at stage 912. Communication between the MDRS 320 and the network topology service 314 is facilitated through standardized APIs, ensuring efficient and reliable data exchange.

Having obtained the high-level NT information, at stage 916, the NSF 610 within the MDRS 320 performs network segmentation. The NSF 610 divides the network into relevant segments based on criteria pertinent to the failed end-to-end network path. This segmentation considers factors such as geographical regions, network domain types, and resource characteristics. By isolating the segments directly related to the failure, the MDRS 320 narrows its focus to the most critical areas, improving the efficiency of the recovery process and reducing computational overhead.

At stage 920, the MDRS 320 queries the observability service 312 for network events and alarms associated with the identified network segments. At stage 924, the observability service 312 provides real-time insights into network performance, including alerts on faults, failures, congestion, and maintenance activities. Obtaining this information helps the MDRS 320 ensure that any potential alternative paths do not include network segments currently experiencing issues or scheduled for maintenance.

At stage 928, following the assessment of events and alarms, the MDRS 320 queries the network topology service 314 again, this time requesting low-level NT details. This detailed information includes specific configurations of network elements, such as node capabilities, link capacities, current utilization levels, latency measurements, and interface specifications. The network topology service 314 updates the MDRS 320 with relevant low-level NT information at stage 932. Access to low-level NT details enables the MDRS 320 to perform a thorough analysis of potential alternative paths, evaluating their feasibility and performance characteristics with precision.

At stage 936, based on the accumulated high-level and low-level network information, as well as the insights from the observability service 312, the MDRS 320 triggers the APGF 325 to execute its core functions. The APGF 325 executes its functions, accordingly, at stage 940. The APGF 325 is responsible for identifying, generating, and evaluating candidate alternative paths that can serve as replacements for the failed network path. It considers both existing paths that are currently underutilized or inactive and new paths that may be created by reconfiguring network resources. AS described herein, within the APGF 325, specialized modules such as the NSF 610, the PWC module 614, and the APPA module 616 work collaboratively to refine the selection process. For example, the PWC module 614 calculates weights for each candidate alternative path based on operator-defined criteria, including bandwidth capacity, latency, reliability, traffic load, and hop count. These weights reflect the suitability of each path in meeting the network's performance objectives and service level agreements (SLAs). The APPA module 616 assigns priorities to the candidate paths based on their calculated weights, ensuring that the most optimal path is selected for implementation.

Turning to FIG. 9B, the call flow 900b is a continuation of the call flow 900a of FIG. 9A. Execution of the APGF 325 features at the bottom of FIG. 9A can result in either successful selection of a new NP from one or more candidate APs (e.g., one or more existing candidate APs and/or one or more new candidate APs generated by the APGF 325) or unsuccessful selection of (or determination or generation of) a new NP by the APGF 325. At stage 944, in the case of a successful new NP selection, the APGF 325 updates the MDRS 320 with the details of the new network path. This includes specific configuration changes required across various network domains, the sequence of actions to reestablish connectivity, and any dependencies or prerequisites that must be addressed.

At stage 948, upon receiving the new network path details, the MDRS 320 initiates the reconfiguration of relevant underlying network domains. This may involve coordinating with an infrastructure management services (IMS) and/or a data management services (DMS) to provision necessary computational and storage resources within the O-Cloud 352. The MDRS 320 may also engage with the transport domains 354 to adjust routing configurations, reserve bandwidth, and establish new virtual circuits as needed. These actions are orchestrated through appropriate interfaces, such as the O1 interface for interactions with O-RAN nodes and the O2 interface for cloud infrastructure management. If the standard interfaces are not supported by certain domains, mechanisms like the MTIF 415 or ETNM 510 are utilized to facilitate communication.

At stage 952, if the reconfiguration succeeds, the MDRS 320 updates its database (DB) 330 with the new network path details. Maintaining an accurate record of the network's current configuration helps to ensure effective ongoing management, auditing, compliance, and future recovery efforts. At stage 956a, the orchestrator 310 then updates the non-RT RIC 316 with the new network state, ensuring that higher-level control functions, policy enforcement mechanisms, and AI/ML models are synchronized with the network's operational state.

At stage 956b, if the reconfiguration fails (e.g., due to factors such as resource constraints, conflicting configurations, or unresolvable dependencies), the MDRS 320 refrains from updating its database with the new NP details. Instead, it ensures that the orchestrator 310 updates the non-RT RIC 316 regarding the failure. This notification allows for the adjustment of policies, re-evaluation of alternative paths, or initiation of manual intervention by the network operator 340. The failure information can assist root cause analysis and can improve the robustness of future recovery attempts.

If the APGF 325 is unsuccessful in selecting or generating a new NP (e.g., due to the absence of viable alternatives or insurmountable constraints), it indicates the failure to the MDRS 320 at stage 960. The MDRS 320, in turn, ensures that the orchestrator 310 updates the non-RT RIC 316 accordingly at stage 956c. The inability to find a suitable alternative path can prompt further actions, such as alerting the network operator 340, reallocating network resources at a higher level, or revising operational policies to expand the scope of acceptable solutions.

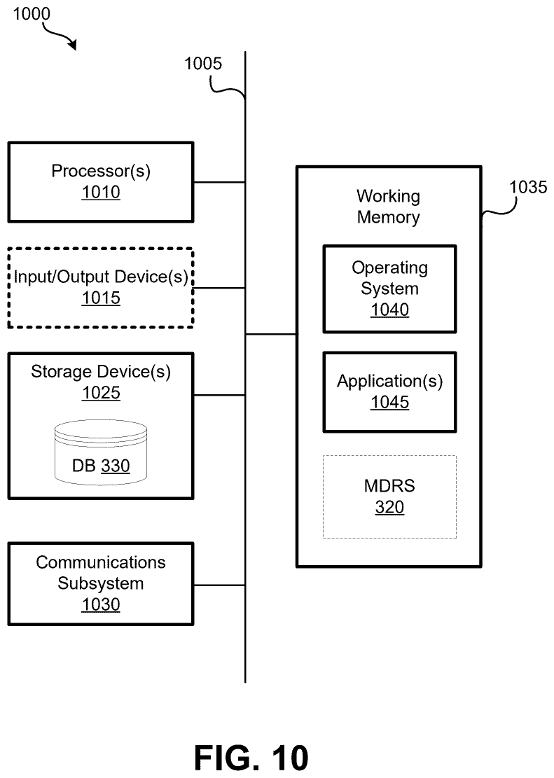

In some embodiments, multi-domain network path recovery features described herein are implemented by a computational environment. The computational environment can be implemented in any suitable one or more nodes of an O-RAN architecture, such as in the cellular network 120 of FIG. 1, or any of the architectures represented in FIGS. 3-6. FIG. 10 provides a schematic illustration of an embodiment of a computational system 1000 that can implement various system components and/or perform various steps of methods provided by various embodiments. It should be noted that FIG. 10 is meant only to provide a generalized illustration of various components, any or all of which may be utilized as appropriate. FIG. 10, therefore, broadly illustrates how individual system elements may be implemented in a relatively separated or relatively more integrated manner.

The computational system 1000 is shown including hardware elements that can be electrically coupled via a bus 1005 (or may otherwise be in communication, as appropriate). The hardware elements may include one or more processors 1010, including, without limitation, a set of (i.e., one or more) general-purpose processors and/or special-purpose processors (such as digital signal processing chips, graphics acceleration processors, video decoders, and/or the like). Optionally, embodiments of the computational system 1000 can include one or more input/output (I/O) devices 1015. The I/O devices 1015 can include user input devices (e.g., a mouse, a keyboard, remote control, touchscreen interfaces, audio interfaces, video interfaces, and/or the like), machine input devices (e.g., computer-to-computer interfaces, such as wired and/or wireless input data ports), user output devices (e.g., display devices, printers, and/or the like), and/or machine input devices (e.g., computer-to-computer interfaces, such as wired and/or wireless output data ports).

The computational system 1000 may further include (and/or be in communication with) one or more non-transitory storage devices 1025, which can comprise, without limitation, local and/or network accessible storage, and/or can include, without limitation, a disk drive, a drive array, an optical storage device, a solid-state storage device, such as a random-access memory (“RAM”), and/or a read-only memory (“ROM”), which can be programmable, flash-updateable and/or the like. Such storage devices may be configured to implement any appropriate data stores, including, without limitation, various file systems, database structures, and/or the like. In some embodiments, the storage devices 1025 include the database 330. The storage devices 1025 can also be used to store any other data for facilitating embodiments herein, such as one or more thresholds, machine learning networks, machine learning training data, etc.

The computational system 1000 can also include a communications subsystem 1030. Embodiments of the communications subsystem 1030 include any suitable components for interfacing with other components and/or nodes of the network in which the computational system 1000 is disposed. For example, as described herein, embodiments communicate with one or more network operators 340, O-RAN nodes 356, O-clouds 352, transport domains 354, interfaces 358, etc. Some embodiments of the communications subsystem 1030 can also include, without limitation, a modem, a network card (wireless or wired), an infrared communication device, a wireless communication device, and/or a chipset (such as a Bluetooth™ device, another 802.11 device, a WiMax device, cellular communication device, etc.), and/or the like.

Embodiments of the computational system 1000 can further include a working memory 1035, which can include a RAM or ROM device, as described herein. The computational system 1000 also can include software elements, shown as currently being located within the working memory 1035, including an operating system 1040, device drivers, executable libraries, and/or other code, such as one or more application programs 1045, which may include computer programs provided by various embodiments, and/or may be designed to implement methods, and/or configure systems, provided by other embodiments, as described herein. Merely by way of example, one or more procedures described with respect to the method(s) discussed herein can be implemented as code and/or instructions executable by a computer (and/or a processor within a computer); in an aspect, then, such code and/or instructions can be used to configure and/or adapt a general-purpose computer (or other device) to perform one or more operations in accordance with the described methods.

In some embodiments, the operating system 1040 and the working memory 1035 are used in conjunction with the one or more processors 1010 to implement a MDRS 320, as described herein. For example, the MDRS 320 can, when stored instructions are implemented by the processor(s) 1010, perform features, such as network path (NP) failure detection, network segmentation, alternate path (AP) identification and/or generation, and new NP selection.

A set of these instructions and/or codes can be stored on a non-transitory (or non-transient) computer-readable storage medium, such as the non-transitory storage device(s) 1025 described above. In some cases, the storage medium can be incorporated within a computer system, such as computational system 1000. In other embodiments, the storage medium can be separate from a computer system (e.g., a removable medium, such as a compact disc), and/or provided in an installation package, such that the storage medium can be used to program, configure, and/or adapt a general-purpose computer with the instructions/code stored thereon. These instructions can take the form of executable code, which is executable by the computational system 1000 and/or can take the form of source and/or installable code, which, upon compilation and/or installation on the computational system 1000 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware can also be used, and/or particular elements can be implemented in hardware, software (including portable software, such as applets, etc.), or both. Further, connection to other computing devices, such as network input/output devices, may be employed.

As mentioned above, in one aspect, some embodiments may employ a computer system (such as the computational system 1000) to perform methods in accordance with various embodiments of the invention. According to a set of embodiments, some or all of the procedures of such methods are performed by the computational system 1000 in response to processor 1010 executing one or more sequences of one or more instructions (which can be incorporated into the operating system 1040 and/or other code, such as an application program 1045) contained in the working memory 1035. Such instructions may be read into the working memory 1035 from another computer-readable medium, such as one or more of the non-transitory storage device(s) 1025. Merely by way of example, execution of the sequences of instructions contained in the working memory 1035 can cause the processor(s) 1010 to perform one or more procedures of the methods described herein.

The terms “machine-readable medium,” “computer-readable storage medium” and “computer-readable medium,” as used herein, refer to any medium that participates in providing data that causes a machine to operate in a specific fashion. These mediums may be non-transitory. In an embodiment implemented using the computational system 1000, various computer-readable media can be involved in providing instructions/code to processor(s) 1010 for execution and/or can be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 1025. Volatile media include, without limitation, dynamic memory, such as the working memory 1035. Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 1010 for execution. Merely by way of example, the instructions may initially be carried on a disk of a remote computer. The remote computer can load the instructions into its dynamic memory and send the instructions as signals over a transmission medium to be received and/or executed by the computational system 1000. The communications subsystem 1030 (and/or components thereof) generally will receive signals, and the bus 1005 then can carry the signals (and/or the data, instructions, etc., carried by the signals) to the working memory 1035, from which the processor(s) 1010 retrieves and executes the instructions. The instructions received by the working memory 1035 may optionally be stored on a non-transitory storage device 1025 either before or after execution by the processor(s) 1010.

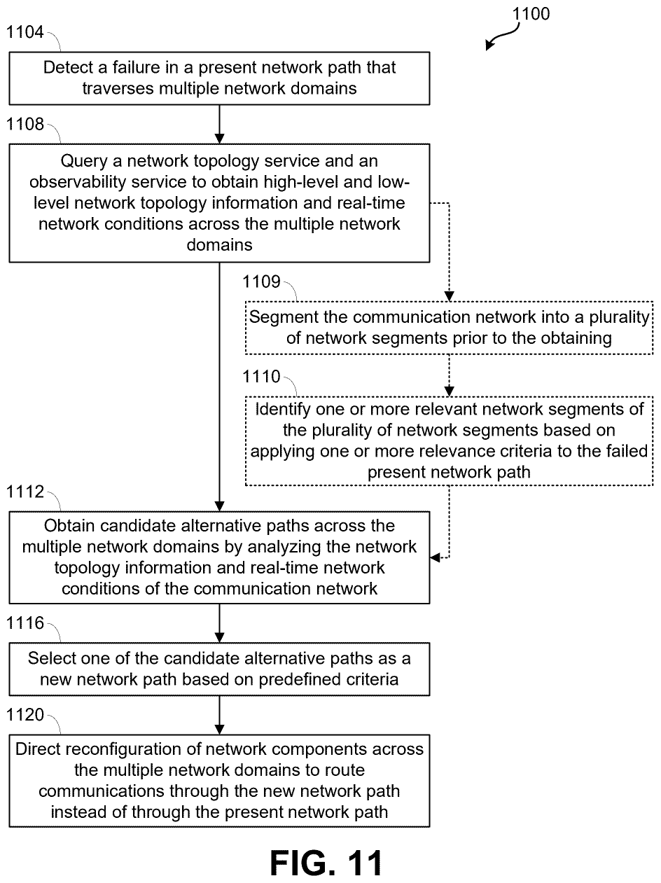

FIG. 11 shows a flow diagram of an illustrative method 1100 for multi-domain network path recovery in an open radio access network (O-RAN) architecture, according to embodiments described herein. Embodiments of the method begin at stage 1104 by detecting a failure in a present network path that traverses multiple network domains. This failure detection can be triggered either autonomously by network functions equipped with artificial intelligence and machine learning capabilities, such as a non-real-time RAN intelligent controller (non-RT RIC), or manually by a network operator. The failure disrupts end-to-end communication between network objects, which can necessitate immediate recovery to maintain network service continuity.

At stage 1108, embodiments can query a network topology service and an observability service to obtain high-level and low-level network topology information and real-time network conditions across the multiple network domains. The network topology service provides detailed information about the network's structural layout, including interconnections between network elements and current topology configurations. The observability service offers real-time insights into network events, alarms, performance metrics, and utilization levels, enabling an up-to-date understanding of the network's operational state.

Prior to the obtaining of candidate alternative paths, at stage 1109, some embodiments can segment the communication network into a plurality of network segments. This segmentation can be based on geographical locations and/or network characteristics such as bandwidth availability, reliability, latency, and traffic load. By dividing the network into manageable segments, the method 1100 can narrow the focus to relevant areas, reducing computational complexity and improving the efficiency of the recovery process. Such embodiments, at stage 1110, can identify one or more relevant network segments of the plurality of network segments based on applying one or more relevance criteria to the failed present network path. The relevance criteria may include factors like proximity to the failure location, resource availability, and the ability of segments to support required network services. This identification can ensure that subsequent analyses concentrate on network segments most suitable for forming alternative paths.

At stage 1112, embodiments can obtain candidate alternative paths across the multiple network domains by analyzing the network topology information and real-time network conditions of the communication network. This analysis can consider both existing underutilized paths and potential new paths formed by reconfiguring network resources. Factors such as link capacities, node capabilities, current traffic loads, and any network issues are evaluated to assess the feasibility of these candidate paths.

At stage 1116, embodiments can select one of the candidate alternative paths as a new network path based on predefined criteria. The selection process can involve calculating weights or scores for each candidate path using operator-defined criteria, including latency, bandwidth capacity, reliability, traffic load, and hop count. Advanced algorithms, possibly incorporating machine learning models trained on historical network performance data, may be employed to rank the candidate paths. The path that optimally balances performance metrics and aligns with service level agreements (SLAs) can be the one selected as the new network path.

At stage 1120, embodiments can direct reconfiguration of network components across the multiple network domains to route communications through the new network path instead of through the present network path. This reconfiguration may involve updating routing tables, adjusting network function parameters, provisioning additional resources, and/or modifying configurations of O-RAN nodes, transport nodes, and/or cloud infrastructure components. Communication with network elements can be facilitated through standard interfaces such as the O1 and O2 interfaces. In some cases, modified interfaces like a modified transport interface (MTIF) or an external transport network manager (ETNM) may be used to interact with domains that do not natively support the standard interfaces. The coordinated reconfiguration helps to ensure that end-to-end connectivity is restored efficiently, minimizing service disruption for end-users.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for dynamically recovering from a network path failure in a communication network, the method comprising:
detecting a failure in a present network path that traverses multiple network domains;
querying, by a multi-domain recovery service (MDRS), a network topology service and an observability service to obtain high-level and low-level network topology information and real-time network conditions across the multiple network domains;
obtaining, by the MDRS, candidate alternative paths across the multiple network domains by analyzing the network topology information and real-time network conditions of the communication network;
selecting, by the MDRS, one of the candidate alternative paths as a new network path based on predefined criteria; and
directing reconfiguration, by the MDRS, of network components across the multiple network domains to route communications through the new network path instead of through the present network path.

2. The method of claim 1, further comprising:
segmenting the communication network into a plurality of network segments prior to the obtaining; and
identifying one or more relevant network segments of the plurality of network segments based on applying one or more relevance criteria to the failed present network path,
wherein the obtaining the candidate paths comprises analyzing the network topology information and real-time network conditions of only the relevant network segments.

3. The method of claim 2, wherein the segmenting the communication network into the plurality of network segments is based on geographical location and/or network characteristics.

4. The method of claim 1, wherein the detecting the failure comprises autonomously detecting the failure by a non-real-time RAN intelligent controller (non-RT RIC) based on predefined policies and real-time network monitoring.

5. The method of claim 1, wherein the detecting the failure comprises detecting a trigger condition based on receiving a notification from a network operator.

6. The method of claim 1, wherein:
the present network path traverses the multiple network domains between a first end point of an open radio access network (O-RAN) and a second end point of the O-RAN; and
the obtaining the candidate alternative paths comprises identifying one or more existing network paths other than the present network path that communicatively couple the first and second end points of the O-RAN.

7. The method of claim 1, wherein:
the present network path traverses the multiple network domains between a first node of an O-RAN and a second node of the O-RAN; and
the obtaining the candidate alternative paths comprises generating one or more new network paths that communicatively couple the first and second nods of the O-RAN.

8. The method of claim 1, wherein the selecting the one of the candidate alternative paths comprises:
calculating weights for each of the candidate alternate paths based on one or more of latency, bandwidth capacity, reliability, traffic load, and hop count; and
ranking the candidate alternate paths according to the calculated weights.

9. The method of claim 1, wherein the selecting the one of the candidate alternative paths comprises:
calculating weights for each of the candidate alternate paths based on one or more operator-defined policies; and
ranking the candidate alternate paths according to the calculated weights.

10. The method of claim 1, wherein the selecting the one of the candidate alternative paths comprises scoring each candidate path using a machine learning model trained on historical network performance data.

11. The method of claim 1, wherein the directing reconfiguration of the network components comprises communicating configuration changes to one or more transport domains using a modified transport interface (MTIF) or an external transport network manager (ETNM).

12. The method of claim 1, wherein the communication network is a wireless communication network implementing an Open Radio Access Network (O-RAN) architecture.

13. A system for dynamic recovery from a network path failure in a communication network, the system comprising:
one or more processors; and
a non-transitory memory having processor readable instructions stored thereon which, when executed, cause the one or more processors to implement a multi-domain recovery service that performs steps comprising:
detecting a failure in a present network path that traverses multiple network domains;
querying a network topology service and an observability service to obtain high-level and low-level network topology information and real-time network conditions across the multiple network domains;
obtaining candidate alternative paths across the multiple network domains by analyzing the network topology information and real-time network conditions of the communication network;
selecting one of the candidate alternative paths as a new network path based on predefined criteria; and
directing reconfiguration of network components across the multiple network domains to route communications through the new network path instead of through the present network path.

14. The system of claim 13, wherein the multi-domain recovery service performs steps further comprising:
segmenting the communication network into a plurality of network segments prior to the obtaining; and
identifying one or more relevant network segments of the plurality of network segments based on applying one or more relevance criteria to the failed present network path,
wherein the obtaining the candidate paths comprises analyzing the network topology information and real-time network conditions of only the relevant network segments.

15. The system of claim 13, wherein the detecting the failure comprises at least one of: autonomously detecting the failure by a non-real-time RAN intelligent controller (non-RT RIC) based on predefined policies and real-time network monitoring; or receiving a failure notification from a network operator.

16. The system of claim 13, wherein:
the present network path traverses the multiple network domains between a first end point of an open radio access network (O-RAN) and a second end point of the O-RAN; and
the obtaining the candidate alternative paths comprises at least one of:
identifying one or more existing network paths other than the present network path that communicatively couple the first and second end points of the O-RAN; or
generating one or more new network paths that communicatively couple the first and second end points of the O-RAN.

17. The system of claim 13, wherein the selecting the one of the candidate alternative paths comprises:
calculating weights for each of the candidate alternate paths based on at least one of: latency, bandwidth capacity, reliability, traffic load, hop count, or one or more operator-defined policies; and
ranking the candidate alternate paths according to the calculated weights.

18. The system of claim 13, wherein the selecting the one of the candidate alternative paths comprises scoring each candidate path using a machine learning model trained on historical network performance data.

19. The system of claim 13, wherein the directing reconfiguration of the network components comprises communicating configuration changes to one or more transport domains using a modified transport interface (MTIF) or an external transport network manager (ETNM).

20. The system of claim 13, wherein the communication network is a wireless communication network implementing an Open Radio Access Network (O-RAN) architecture.
